(19) United States
(12) Patent Application Publication
(10) Pub. No.: US 2015/0143033 A1
(43) Pub. Date: May 21, 2015

(54) CONTROLLING WRITE SPEED OF NONVOLATILE MEMORY DEVICE

(71) Applicants: HYUN-JU KIM, HWASEONG-SI (KR); DONGGI LEE, YONGIN-SI (KR); WONCHUL JU, SEOUL (KR); HYUNG-KYUN BYUN, YONGIN-SI (KR); SONGHO YOON, YONGIN-SI (KR)

(72) Inventors: HYUN-JU KIM, HWASEONG-SI (KR); DONGGI LEE, YONGIN-SI (KR); WONCHUL JU, SEOUL (KR); HYUNG-KYUN BYUN, YONGIN-SI (KR); SONGHO YOON, YONGIN-SI (KR)

(21) Appl. No.: 14/524,251

(22) Filed: Oct. 27, 2014

(30) Foreign Application Priority Data
Nov. 21, 2013 (KR) 10-2013-0142286

(51) Int. Cl. G06F 3/06; G06F 12/02

(52) U.S. Cl. CPC G06F 3/0611; G06F 3/0679; G06F 3/0634; G06F 12/0253; G06F 2206/1014; G06F 2212/702; G06F 2212/7205
USPC 711/103

(57) ABSTRACT

A system comprises a nonvolatile memory device having multiple download speeds, and a computing device connected to the nonvolatile memory device and configured to determine a download environment of the nonvolatile memory device and to set the nonvolatile memory device to one of the download speeds according to the determined download environment.

### CROSS-REFERENCE TO RELATED APPLICATIONS

This application claims priority under 35 U.S.C. §119 to Korean Patent Application No. 10-2013-0142286 filed Nov. 21, 2013, the subject matter of which is hereby incorporated by reference.

### BACKGROUND OF THE INVENTION

The inventive concept relates generally to electronic memory technologies. More particularly, certain embodiments relate to techniques for controlling the write speed of a nonvolatile memory device.

Most electronic devices comprise at least one memory device for storing data. Examples of the stored data may include, without limitation, a boot loader, an operating system (OS) image, main system data, application programs. Such a memory device may be placed in the electronic device during a mass production process. In such a process, data may first be stored in the memory device before it is mounted on the electronic device. Then, the storage may be mounted in the electronic device through an assembly process. Finally, data is stored in the memory device may be mounted in the electronic device.

In general, the time taken to ship electronic devices at a mass production level may be affected by the time taken to store data in each memory device. Accordingly, it is generally beneficial to reduce this time.

### SUMMARY OF THE INVENTION

In one embodiment of the inventive concept, a system comprises a nonvolatile memory device having multiple download speeds, and a computing device configured to be connected to the nonvolatile memory device, to determine a download environment of the nonvolatile memory device, and to set the nonvolatile memory device to one of the download speeds according to the determined download environment.

In another embodiment of the inventive concept, a nonvolatile memory device comprises a storage medium configured to store data, and a controller configured to control the storage medium. The controller is configured to variably control a download speed where data provided from an external device is stored in the storage medium, based on setting information provided from the external device.

In still another embodiment of the inventive concept, a method, comprises performing a pre surface mount technology (SMT) write operation where data is downloaded from a computing device into a nonvolatile memory device having multiple mass production download speeds, the nonvolatile memory device being set to one of the mass production download speeds by the computing device, mounting the nonvolatile memory device on a mobile device, and performing a post-SMT write operation where data is downloaded from the computing device into the nonvolatile memory device mounted on the mobile device, the nonvolatile memory device being set to a mass production download speed used for the pre-SMT write operation or to one of remaining mass production download speeds other than the mass production download speed used for the pre-SMT write operation. A write performance corresponding to the mass production download speed used for the pre-SMT write operation and a write performance corresponding to a mass production download speed used for the post-SMT write operation are better than a write performance corresponding to a normal download speed of the nonvolatile memory device.

These and other embodiments of the inventive concept may potentially improve the production efficiency of electronic devices by shortening an amount of time required to download data into a nonvolatile memory device.

### BRIEF DESCRIPTION OF THE DRAWINGS

The drawings illustrate selected embodiments of the inventive concept. In the drawings, like reference numbers indicate like features.

FIG. 1 is a flowchart illustrating a mass production process according to an embodiment of the inventive concept.

FIG. 2 is a diagram illustrating a pre surface mount technology (pre-SMT) write step in the method of FIG. 1, according to an embodiment of the inventive concept.

FIG. 3 is a flowchart illustrating a pre-SMT write step in the method of FIG. 1, according to an embodiment of the inventive concept.

FIG. 4 is a flowchart illustrating a pre-SMT write step in the method of FIG. 1, according to another embodiment of the inventive concept.

FIG. 5 is a diagram illustrating a post-SMT write step in the method of FIG. 1.

FIG. 6 is a flowchart illustrating a post-SMT write step in the method of FIG. 1, according to an embodiment of the inventive concept.

FIG. 7 is a flowchart illustrating a post-SMT write step in the method of FIG. 1, according to another embodiment of the inventive concept.

FIG. 8 is a diagram illustrating a mass production procedure comprising a pre-SMT write step and a post-SMT write step, according to an embodiment of the inventive concept.

FIG. 9 is a diagram illustrating a mass production procedure comprising a pre-SMT write step and a post-SMT write step, according to another embodiment of the inventive concept.

FIG. 10 is a diagram illustrating a mass production procedure comprising a pre-SMT write step and a post-SMT write step, according to still another embodiment of the inventive concept.

FIG. 11 is a diagram illustrating a mass production procedure comprising a post-SMT write step, according to a further embodiment of the inventive concept.

FIG. 12 is a diagram illustrating a method of selecting supportable write modes of a memory device in a mobile device according to an interface speed between a mobile device and a computing device.

FIG. 13 is a block diagram illustrating a nonvolatile memory device according to an embodiment of the inventive concept.

FIG. 14 is a block diagram illustrating a memory controller in the method of FIG. 13.

FIG. 15 is a block diagram illustrating a storage medium in the method of FIG. 13.

### DETAILED DESCRIPTION

Embodiments of the inventive concept are described below with reference to the accompanying drawings. These embodiments are presented as teaching examples and should not be construed to limit the scope of the inventive concept.

In the description that follows, the terms “first”, “second”, “third”, etc., are used to describe various features, but the described features should not be limited by these terms. Rather, these terms are used merely to distinguish between different features. For example, a first feature discussed below could alternatively be termed a second feature, and vice versa, without departing from the teachings of the inventive concept.

The terminology used herein is for the purpose of describing embodiments only and is not intended to limit the scope of the inventive concept. As used herein, the singular forms “a”, “an” and “the” are intended to include the plural forms as well, unless the context clearly indicates otherwise. Terms such as “comprises” and/or “comprising,” where used herein, specify the presence of stated features, but do not preclude the presence or addition of one or more other features. As used herein, the term “and/or” includes any and all combinations of one or more of the associated listed items.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and/or the present specification and will not be interpreted in an idealized or overly formal sense unless expressly so defined herein.

The following description presents various examples of a write method to be applied in connection with certain types of nonvolatile memory devices. However, the inventive concept is not limited to these examples. In general, the described examples may shorten a time taken to download data into a nonvolatile memory device, which can improve production efficiency. Here, downloading may comprise operations for transferring data from an external device (e.g., a computing device) to a nonvolatile memory device, and operations for programming the transferred data in storage medium of the nonvolatile memory device. A download speed may correspond to a write mode.

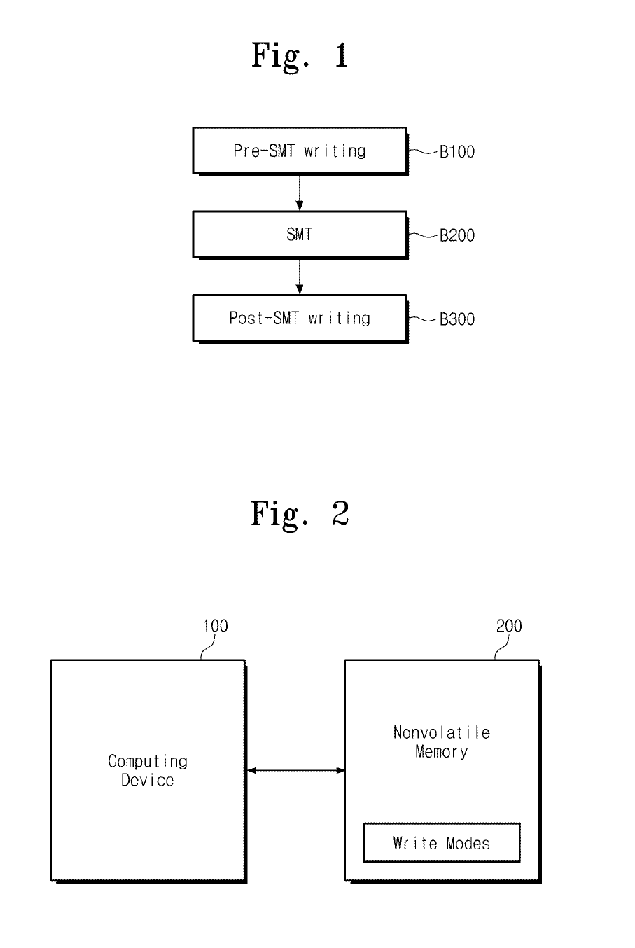

FIG. 1 is a flowchart illustrating a mass production process according to an embodiment of the inventive concept.

Referring to FIG. 1, the mass production process comprises a pre-SMT write step B100, an SMT step B200, and a post-SMT write step S300. In pre-SMT write step B100, one or more nonvolatile memory devices are connected to a computing device, and data is downloaded into the one or more nonvolatile memory devices from the computing device. This operation is generally referred to as a Gang program operation. In pre-SMT write step B100, basic data (e.g., a boot loader, an OS image, and so on) of a mobile device (e.g., a smart phone, a tablet PC, and so on) in which a nonvolatile memory device is to be mounted is downloaded into the nonvolatile memory device from the computing device. Here, downloading may comprise an operation of transferring data from the computing device to the nonvolatile memory device, and an operation of programming the transferred data in the nonvolatile memory device (or, storage medium of the nonvolatile memory device).

In some embodiments, pre-SMT write step B100 comprises an operation where the computing device sets up a write mode of the nonvolatile memory device. Alternatively, pre-SMT write step B100 may comprise operations allowing the nonvolatile memory device to provide supportable write modes to the computing device, allowing the computing device to select one of the supportable write modes, and allowing the computing device to set the nonvolatile memory device with the selected write mode. In particular, a write mode of the nonvolatile memory device may be decided based on an environment of a nonvolatile memory device (e.g., a download/write environment of a nonvolatile memory device associated with whether a nonvolatile memory device is mounted on a mobile device), the size of data to be downloaded, an interface speed, etc. Afterwards, an operation of setting up a write mode of a nonvolatile memory device may be referred to as a register setting operation. However, the register setting operation is not limited to the described examples.

In SMT step B200, as an assembly step, a nonvolatile memory device storing data downloaded in pre-SMT write step B100 is mounted on a mobile device. In post-SMT write step B300, a computing device is connected with the mobile device including the nonvolatile memory device into which data is downloaded in pre-SMT write step B100. Here, the mobile device and the computing device may be connected through one of various wired or wireless communication protocols. For example, the mobile device and the computing device may be connected through a USB protocol. After the mobile device is connected to the computing device, data is downloaded from the computing device to the mobile device.

In some embodiments, post-SMT write step B300 comprises an operation where the computing device sets up a write mode (or, a download speed) of the nonvolatile memory device. Alternatively, post-SMT write step B300 may comprise operations allowing the nonvolatile memory device to provide supportable write modes (or, write modes for mass production) to the computing device, allowing the computing device to select one of the supportable write modes, and allowing the computing device to set the nonvolatile memory device with the selected write mode. In particular, a write mode of the nonvolatile memory device may be decided based on an environment of a nonvolatile memory device (e.g., a download/write environment of a nonvolatile memory device associated with whether a nonvolatile memory device is mounted on a mobile device), the size of data to be downloaded, an interface speed, etc.

With the mass production procedure described above, during the pre-SMT and post-SMT write steps B100 and B300, a write mode (or, a download speed) of a nonvolatile memory device/mobile device may be selected considering the above-describe environment of the nonvolatile memory device. The write mode may comprise conditions such as, e.g., reliability, write performance, the size of data to be downloaded, an interface manner between a computing device and a mobile device, and so on. In general, there may be a trade-off relationship between the write performance and the reliability. For example, improvement of the write performance may lower the reliability; improvement of the reliability may decrease the write performance. Write performance of a write mode selected according to the described write method may be set to be better than that of a normal write mode of a nonvolatile memory device, as will be described in further detail. Here, the write mode may be associated with a corresponding download speed.

As indicated by the above description, a time taken to download data into a nonvolatile memory device (i.e., a “download time”) may be shortened by downloading data into the nonvolatile memory device according to a write mode or a download speed having a write performance set to be better than a write performance of a normal write mode of a nonvolatile memory device. Thus, mass production efficiency may be improved.

In some embodiments, a mass production method of a mass production system comprises the following operations: (1) performing a pre-SMT write operation where data is downloaded from a computing device into a nonvolatile memory device having multiple mass production download speeds, the nonvolatile memory device being set to one of the mass production download speeds by the computing device; (2) mounting the nonvolatile memory device on a mobile device; and (3) performing a post-SMT write operation where data is downloaded into the nonvolatile memory device mounted on the mobile device, the nonvolatile memory device being set to a mass production download speed used for the pre-SMT write operation or to one of remaining mass production download speeds other than the mass production download speed used for the pre-SMT write operation. A write performance corresponding to the mass production download speed used for the pre-SMT write operation and a write performance corresponding to a mass production download speed used for the post-SMT write operation are better than a write performance of a normal download speed of the nonvolatile memory device.

Here, the mass production download speeds may be varied by a program manner and a program time of the nonvolatile memory device, and also by a background operation associated with a write operation of the downloaded data. The nonvolatile memory device comprises a storage medium comprising a multi-level cell (MLC) memory having a MLC program manner and a SLC program manner, the MLC memory storing data. The mass production download speeds are implemented by one of operations of setting a program manner of the nonvolatile memory device to the SLC program manner, changing a program time for storing data in the storage medium, and delaying an execution time point of the background operation or by a combination of two or more thereof. A background operation associated with a write operation of the downloaded data is held until a designated time point when the nonvolatile memory device is detached from the computing device, and the held background operation is performed in a state where the nonvolatile memory device is disconnected from the computing device. The mobile device comprises an interface device providing an interface between the nonvolatile memory device and the computing device, and the nonvolatile memory device supports all or a part of the download speeds according to an interface speed of the interface device.

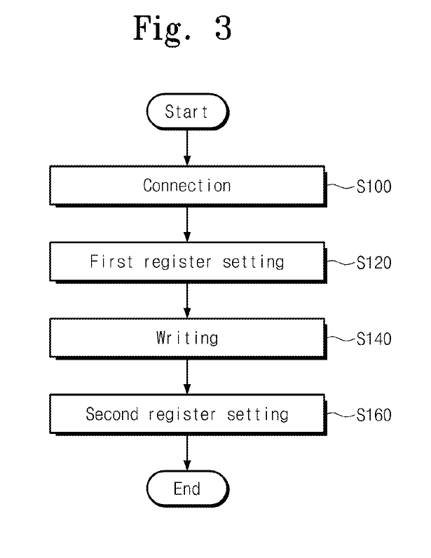

FIG. 2 is a diagram illustrating a pre-SMT write step in the method of FIG. 1, according to an embodiment of the inventive concept.

Referring to FIG. 2, and as described above with reference to FIG. 1, pre-SMT write step B100 is performed prior to SMT step B200. During pre-SMT write step B100, data stored in a computing device 100 is downloaded into one or more nonvolatile memory devices 200 connected to computing device 100. For ease of description, only one nonvolatile memory device is illustrated in FIG. 2. However, two or more nonvolatile memory devices may be connected to computing device 100 for gang programming. Here, computing device 100 may be a ROM writer, also referred to as a gang programmer. However, computing device 100 is not limited to this example.

During pre-SMT write step B100, data for basic operations of a mobile device on which nonvolatile memory device 200 is to be mounted may be downloaded into nonvolatile memory device 200 connected to computing device 100. Because data for basic operations (e.g., a boot loader and/or OS image) is stored in nonvolatile memory device 200, nonvolatile memory device 200 may be used as a boot memory of a mobile device. As described above, downloading may include an operation of transferring data from computing device 100 to nonvolatile memory device 200 and an operation of programming the transferred data in nonvolatile memory device 200 (or, storage medium of nonvolatile memory device 200).

Nonvolatile memory device 200 may be a MLC memory that stores m-bit data (m>1) per cell. For example, nonvolatile memory device 200 may be a memory that stores 2-bit data per cell, which is referred to as a MLC memory. Alternatively, nonvolatile memory device 200 may be a memory that stores 3-bit data per cell, which is referred to as a three-level cell (TLC) memory. However, nonvolatile memory device 200 is not limited to the described examples. Nonvolatile memory device 200 comprises a storage medium in which data is stored, and the storage medium is formed of one or more nonvolatile memory devices such as a flash memory device, a magnetic RAM (MRAM), a resistive RAM (RRAM), a phase-change RAM (PRAM), a ferroelectric RAM (FRAM), and the like.

Nonvolatile memory device 200 may further comprise a controller (or, a memory controller) that controls the storage medium. Nonvolatile memory device 200 supports a variety of write modes. Download speeds respectively corresponding to the write modes may be different from one another. A write mode/download speed may be decided considering an environment of a nonvolatile memory device, reliability, write performance, size of data to be downloaded, etc.

In some embodiments, a download speed may be changed by controlling conditions such as a program manner of an MLC/TLC memory, a program time, background operations (e.g., a garbage collection operation, a refresh operation, and so on), etc. That is, a write mode may be decided based on such conditions. However, a method of changing a write mode/download speed is not limited to the described examples.

A download speed may be changed through an operation of setting a program manner of the MLC/TLC memory to a low-level program manner, an operation of shortening an effective program time of a storage medium in the MLC/TLC memory, an operation of delaying a background operation of the MLC/TLC memory, a combination of at least two of the operations, or a combination of all the operations. Also, such conditions may be used to control reliability of data, write performance, etc. In other words, reliability of data, write performance, etc. may be changed through such conditions. Reliability and write performance levels of write modes may be different from one another. That is, download speeds corresponding to the write modes may be different from one another.

In some embodiments, a mass production system comprises a nonvolatile memory device having multiple download speeds, and a computing device connected to the nonvolatile memory device. The nonvolatile memory device may be set to one of the download speeds according to a download environment of the nonvolatile memory device under a control of the computing device.

The download speeds may correspond to mass production write modes, respectively. Performance of the mass production write mod may be different from one another. Each of the download speeds may be decided by a program manner and a program time of the nonvolatile memory device. The nonvolatile memory device may comprise a storage medium formed of a MLC memory having a MLC program manner and a SLC program manner, the MLC memory storing data. The download speed may be changed by setting a program manner of the nonvolatile memory device to the SLC program manner and/or by changing a program time when data is actually stored in the storage medium.

A background operation of a mass production write mode corresponding to the set download speed may be held until a designated time point when the nonvolatile memory device is detached from the computing device, and the background operation may include a garbage collection operation and a data refresh operation.

In the event that an assembly process is not performed to mount the nonvolatile memory device on a mobile device, a download speed of the nonvolatile memory device may be selected to have a write performance, lower than a maximum write performance, from among write performances of the mass production write modes better than write performance of a normal write mode of the nonvolatile memory device. In the event that the assembly process is performed, a download speed of the nonvolatile memory device may be selected to have a maximum write performance of write performances of the mass production write modes better than a write performance of a normal write mode of the nonvolatile memory device.

FIG. 3 is a flowchart illustrating a pre-SMT write step in the method of FIG. 1, according to an embodiment of the inventive concept. The write step of FIG. 3 will be described with reference to FIGS. 1 through 3.

Referring to FIG. 3, in step S100, nonvolatile memory device 200 is connected to computing device 100. Computing device 100, for example, may include a board on which multiple nonvolatile memory devices is mounted. Data (e.g., a boot loader, an OS image, and so on) of a mobile device on which nonvolatile memory device 200 is to be mounted may be downloaded into the nonvolatile memory devices mounted on the board through computing device 100. For ease of description, a pre-SMT write method will be described with reference to a nonvolatile memory device. However, the pre-SMT write method can be applied to other nonvolatile memory devices mounted on the board.

Once nonvolatile memory device 200 is connected to computing device 100, in step S120, computing device 100 sets a write mode of nonvolatile memory device 200. The write mode is typically set through a register setting operation of nonvolatile memory device 200.

Nonvolatile memory device 200 may support a variety of write modes, and download speeds respectively corresponding to the write modes may be different from one another. Each write mode may be determined in consideration of data reliability, write performance, size of data to be downloaded, or any of several other factors. For example, data stored in nonvolatile memory device 200 before nonvolatile memory device 200 is mounted on a mobile device may be affected by an environment of an SMT step, such as a high-temperature environment. Under these circumstances, a write mode may be determined based on the data reliability rather than the write performance of the write mode. On the other hand, data stored in nonvolatile memory device 200 after nonvolatile memory device 200 is mounted on a mobile device may not be affected by a high temperature of the SMT step. Under these circumstances, a write mode may be determined based on the write performance of the write mode rather than the data reliability.

In step S120, thus, a write mode is selected to improve the write performance while maintaining data reliability, although data downloaded into nonvolatile memory device 200 may be affected by a temperature of the SMT step. In step S120, computing device 200 may set nonvolatile memory device 200 with information indicating a start of the pre-SMT write operation. Nonvolatile memory device 200 may select one of supportable write modes based on such information.

In some embodiments, conditions of a write mode set in step S120 may include a program manner of nonvolatile memory device 200, a program time, a background operation, and so on. A variety of write modes may be implemented by controlling such conditions. In other words, a download speed corresponding to a write mode may be changed by controlling such conditions.

Where nonvolatile memory device 200 comprises a storage medium storing 2-bit data per cell, it may support a MLC program manner where 2-bit data is stored in a memory cell and a SLC program manner where 1-bit data is stored in a memory cell. A time taken to perform a program operation according to the MLC program manner may be longer than a time taken to perform a program operation according to the SLC program manner. Alternatively, where nonvolatile memory device 200 comprises a storage medium storing 3-bit data per cell, it may support a TLC program manner where 3-bit data is stored in a memory cell, a MLC program manner where 2-bit data is stored in a memory cell, and a SLC program manner where 1-bit data is stored in a memory cell. A time taken to perform a program operation according to the TLC program manner may be longer than a time taken to perform a program operation according to the MLC program manner, and a time taken to perform a program operation according to the MLC program manner may be longer than a time taken to perform a program operation according to the SLC program manner. A write mode/download speed may be variously implemented by changing a program manner of nonvolatile memory device 200.

It is possible to adjust a program time tPROG when data transferred from computing device 100 to a storage medium of nonvolatile memory device 200 is actually programmed. For example, program time tPROG of the storage medium of nonvolatile memory device 200 may be changed by controlling an initial level of a program voltage, the number of program loops, etc. Thus, a write mode/download speed may be variously implemented by changing a program time of nonvolatile memory device 200.

A time point where a background operation such as garbage collection is performed may be variable. For example, execution time points and execution times of the garbage collection may be held or delayed until a designated time point. A background operation thus delayed may be carried out at the designated time point. Thus, a write mode/download speed may be variously implemented by changing an execution time point/time of a background operation of nonvolatile memory device 200.

Considering the above-described conditions, a trade-off may exist between data reliability and write performance. For example, improvement of write performance may be restricted in order to achieve a desired level of data reliability. On the other hand, data reliability may be restricted in order to achieve a desired level of write performance. Data reliability and write performance may depend on the above-described conditions. That is, data reliability may vary according to an increase in write performance. Before an SMT step is carried out, a write mode may be selected to improve the write performance while securing the data reliability. For example, in step S120, a write mode may be selected with a write performance between a write performance of a normal write mode and a maximum write performance of nonvolatile memory device 200.

After a write mode of nonvolatile memory device 200 is established, in step S140, data (e.g., a boot loader, an OS image, and so on) for basic operations of a mobile device on which nonvolatile memory device 200 is to be mounted may be downloaded into nonvolatile memory device 200 through computing device 100. Here, downloading may comprise an operation of transferring data from computing device 100 to nonvolatile memory device 200 and an operation of programming the transferred data in nonvolatile memory device 200 (or, storage medium of nonvolatile memory device 200). Data transferred from computing device 100 may be stored in a storage medium of nonvolatile memory device 200 according to conditions of the write mode set in step S120. For example, data transferred from computing device 100 may be stored in a storage medium of nonvolatile memory device 200 according to the SLC program manner (in the case of an MLC memory) or according to an SLC/MCL program manner (in the case of a TLC memory). Under these circumstances, a background operation such as garbage collection may be held. Also, in some circumstances, program time tPROG may be shortened.

In step S160, computing device 100 sets nonvolatile memory device 200 with information indicating an end of the pre-SMT write operation. Afterwards, the pre-SMT write operation may be ended.

In some embodiments, a background operation delayed in step S120 is performed within nonvolatile memory device 200 at a designated time point. This will be more fully described with reference to accompanying drawings.

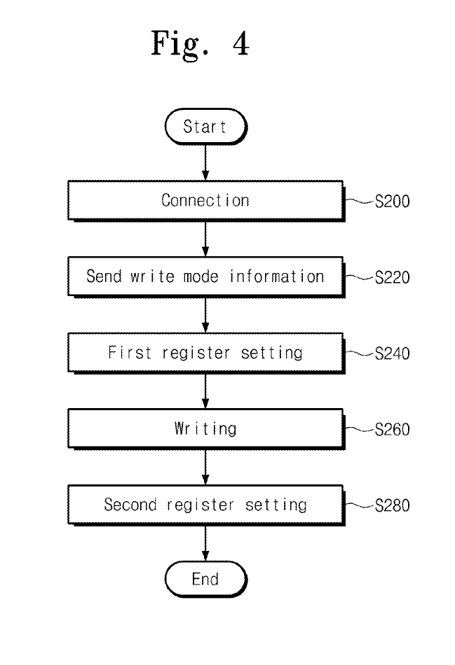

FIG. 4 is a flowchart illustrating a pre-SMT write step in the method of FIG. 1, according to another embodiment of the inventive concept. Below, a pre-SMT write step according to an embodiment of the inventive concept will be more fully described with reference to FIGS. 1, 2, and 4.

In step S200, nonvolatile memory device 200 is connected to computing device 100. Computing device 100, for example, may include a board on which multiple nonvolatile memory devices are mounted. Data (e.g., a boot loader, an OS image, and so on) of a mobile device on which nonvolatile memory device 200 is to be mounted may be downloaded into the nonvolatile memory devices mounted on the board through computing device 100. For convenience of description, a pre-SMT write method will be described with reference to a nonvolatile memory device. However, the described method can be applied to other nonvolatile memory devices mounted on the board.

Once nonvolatile memory device 200 is connected to computing device 100, in step S220, nonvolatile memory device 200 provides computing device 100 with write mode information. Here, the write mode information may include a variety of write modes. In step S240, computing device 100 sets up a write mode of nonvolatile memory device 200 based on the write mode information. That is, a register setting operation about nonvolatile memory device 200 is performed in step S240. Computing device 100 selects a write mode for improving the write performance while securing the data reliability, although data downloaded into nonvolatile memory device 200 is affected by a temperature of a SMT step. Nonvolatile memory device 200 may be set up with the write mode selected by computing device 100.

After a write mode of nonvolatile memory device 200 is set up, in step S260, data (e.g., a boot loader, an OS image, and so on) for basic operations of a mobile device on which nonvolatile memory device 200 is to be mounted may be downloaded into nonvolatile memory device 200 through computing device 100. Here, downloading may include an operation of transferring data from computing device 100 to nonvolatile memory device 200 and an operation of programming the transferred data in nonvolatile memory device 200 (or, storage medium of nonvolatile memory device 200). Data transferred from computing device 100 may be stored in a storage medium of nonvolatile memory device 200 according to conditions of the write mode set in step S240. For example, data transferred from computing device 100 may be stored in a storage medium of nonvolatile memory device 200 according to the SLC program manner (in case of an MLC memory) or according to an SLC/MCL program manner (in case of a TLC memory). In this case, a background operation such as garbage collection may be held (e.g., postponed). Also, in some cases, program time tPROG may be shortened.

In step S280, computing device 100 sets nonvolatile memory device 200 with information indicating an end of the pre-SMT write operation. Afterwards, the pre-SMT write operation may be ended.

In some embodiments, a background operation delayed in step S260 may be performed within nonvolatile memory device 200 at a designated time point. This will be more fully described with reference to accompanying drawings.

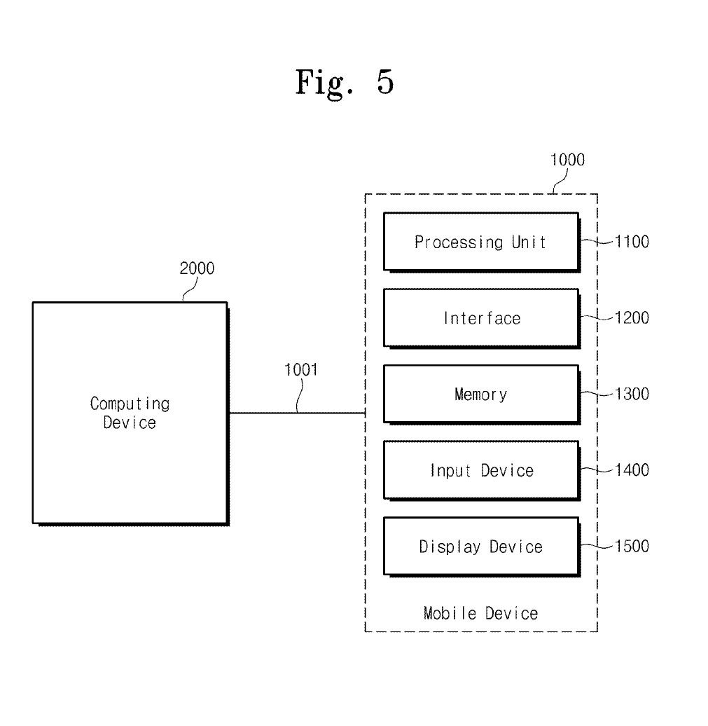

FIG. 5 is a diagram illustrating a post-SMT write step in the method of FIG. 1.

Referring to FIG. 5, a mobile device 1000 is connected to a computing device 2000 through a link 1001 and comprises a processing unit 1100, a communication interface 1200, a memory 1300, an input device, and a display device 1500. For example, mobile device 1000 may include a PDA, a cellular phone, a mobile phone, a mobile communication device, a portable electronic device, a smart phone, and the line. However, mobile device 1000 of the inventive concept is not limited thereto.

Processing unit 1100 comprises any suitable processor, or combination of processors, including but not limited to a microprocessor, a central processing unit (CPU), and the like. Other suitable processors are within the scope of the inventive concept.

Communication interface 1200 comprises any suitable communication interface, or combination of communication interfaces. In particular, communication interface 1200 is enabled to communicate according to any suitable protocol which is compatible with the link 1001, including but not limited to wired protocols, USB (universal serial bus) protocols, serial cable protocols, wireless protocols, cell-phone protocols, wireless data protocols, Bluetooth protocols, NFC (near field communication) protocols and the like, and/or a combination.

Memory 1300 can be any suitable memory device, including but not limited to any suitable one of, or combination of, volatile memory, nonvolatile memory device, random access memory (RAM), flash memory, and the like. Memory 1300 may be used as main storage of mobile device 1000, and it may be implemented by a nonvolatile memory device 200 shown in FIG. 2. That is, memory 1300 may be a nonvolatile memory device into which data for basic operations of mobile device 1000 is downloaded through a pre-SMT write operation. As will be described later, application programs may be stored in memory 1300 through a post-SMT write method.

Input device 1400 is generally enabled to receive input data and can comprise any suitable combination of input devices, including but not limited to a keyboard, a keypad, a pointing device, a mouse, a track wheel, a trackball, a touchpad, a trackpad, a touch screen and the like. Other suitable input devices are within the scope of the inventive concept. Display device 1500 may include a flat panel display (e.g., LCD, OLED, capacitive or resistive touchscreens, and the like).

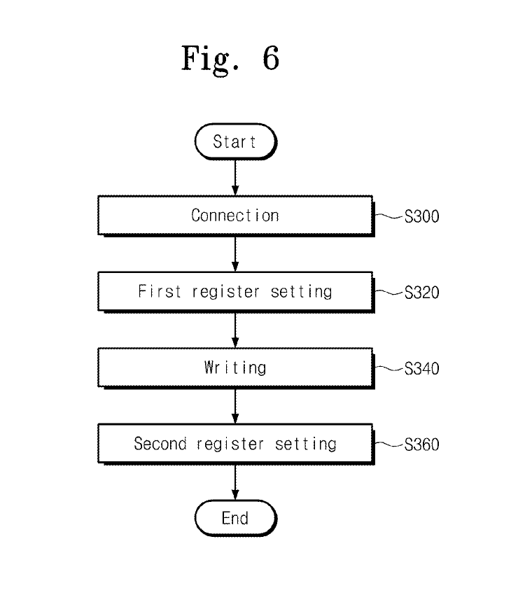

FIG. 6 is a flowchart illustrating a post-SMT write step in the method of FIG. 1, according to an embodiment of the inventive concept. The post-SMT write step will be described with reference to FIGS. 1, 5, and 6.

In step S300, a mobile device 1000 is connected to a computing device 2000. For example, a communication interface 1200 of mobile device 1000 is connected to computing device 2000 through a link 1001 such as a USB cable. Various types of application programs of mobile device 1000 may be downloaded into a memory device 1300 of mobile device 1000 from computing device 2000 through the USB cable. For ease of description, a post-SMT write method of the inventive concept will be described with reference to one mobile device. However, the post-SMT write method may be to multiple mobile device connected to computing device 2000.

Once mobile device 1000 is connected to computing device 2000, in step S320, computing device 2000 sets a write mode of the memory device 1300 in mobile device 1000. That is, a register setting operation about memory 1300 may be performed in step S320. As described above, memory 1300 supports a variety of write modes. Download speeds respectively corresponding to the write modes may be different from one another. Each write mode may be decided considering data reliability, write performance, size of data to be downloaded, etc.

Unlike data stored in memory 1300 before memory 1300 is mounted on mobile device 1000, data stored in memory 1300 after memory 1300 is mounted on mobile device 1000 may not be affected by an environment (or, a high-temperature environment) of an SMT step. Thus, because data downloaded into memory 1300 is not affected by a temperature of the SMT step, in step S320, there is selected a write mode for improving a write performance while securing the data reliability. Here, a write mode may be selected such that a post-SMT write performance becomes better than a pre-SMT write performance. In step S320, computing device 2000 sets memory 1300 in mobile device 1000 with information indicating a start of a post-SMT write operation. Memory 1300 may select one of supportable write modes based on such information.

Considering the conditions described above with reference to FIG. 3, a trade-off may exist between data reliability and write performance. For example, improvement of the write performance may be restricted in order to achieve a desired level of data reliability, or data reliability may be restricted in order to achieve a desired level of write performance. The data reliability and the write performance may depend on the above-described conditions. That is, the data reliability may vary according to an increase in write performance. After the SMT step is carried out, a write mode may be decided to improve the write performance while securing the data reliability. For example, in step S320, there is selected a write mode having a maximum write performance better than a write performance of a normal write mode and the pre-SMT write performance.

After a write mode of memory 1300 is set up, in step S340, various application programs of a mobile device on which memory 1300 is mounted may be downloaded from computing device 2000 into memory 1300. Here, downloading may include an operation of transferring data from computing device 2000 to memory 1300 and an operation of programming the transferred data in memory 1300. Data transferred from computing device 2000 may be stored in a storage medium of memory 1300 according to conditions of the write mode set in step S320. For example, data transferred from computing device 2000 may be stored in a storage medium of memory 1300 according to the SLC program manner (in an MLC memory) or according to an SLC/MCL program manner (in a TLC memory). In this case, a background operation such as garbage collection may be held. Also, in some cases, program time tPROG may be shortened.

In step S360, computing device 2000 sets memory 1300 with information indicating an end of the post-SMT write operation. Afterwards, the post-SMT write operation may be ended.

In some embodiments, a background operation delayed in step S340 is performed within memory 1300 at a designated time point. This will be more fully described below.

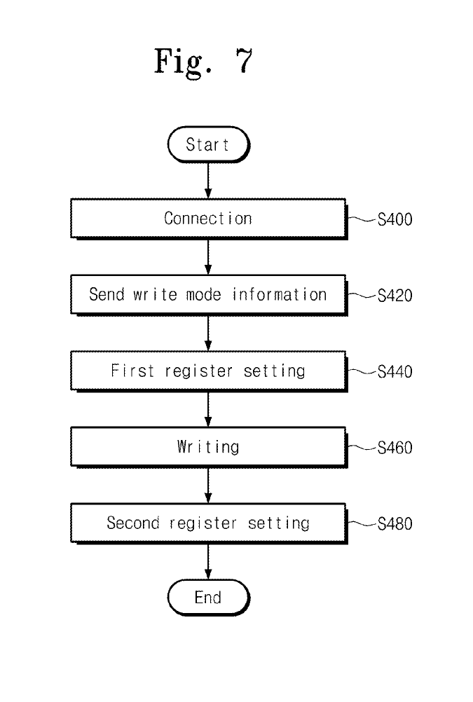

FIG. 7 is a flowchart illustrating a post-SMT write step in the method of FIG. 1, according to another embodiment of the inventive concept. The post-SMT write step will be described with reference to FIGS. 1, 5, and 7.

In step S400, a mobile device 1000 is connected to a computing device 2000. For example, a communication interface 1200 of mobile device 1000 is connected to computing device 2000 through a link 1001 such as a USB cable. Various types of application programs of mobile device 1000 may be downloaded into a memory device 1300 of mobile device 1000 from computing device 2000 through the USB cable. For ease of description, a post-SMT write method of the inventive concept will be described with reference to one mobile device. However, it is understood that the post-SMT write method is identically applied to multiple mobile device connected to computing device 2000.

Once mobile device 1000 is connected to computing device 2000, in step S420, the corresponding memory 1300 provides computing device 2000 with write mode information. Here, the write mode information may include a variety of write modes. In step S440, computing device 2000 sets a write mode of memory 1300 in mobile device 1000 based on the write mode information. That is, a register setting operation about memory 1300 in mobile device 1000 may be performed in step S440.

Unlike data stored in memory 1300 before memory 1300 is mounted on mobile device 1000, data stored in memory 1300 after memory 1300 is mounted on mobile device 1000 may not be affected by an environment (or, a high-temperature environment) of an SMT step. Thus, because data downloaded into memory 1300 is not affected by a temperature of the SMT step, in step S440, there is selected a write mode for improving a write performance while securing the data reliability. Here, a write mode may be selected such that a post-SMT write performance becomes better than a pre-SMT write performance. In step S440, computing device 2000 sets memory 1300 in mobile device 1000 with information indicating a start of a post-SMT write operation. Memory 1300 may select one of supportable write modes based on such information.

Considering the above-described conditions described with reference to FIG. 3, a trade-off may exist between data reliability and write performance. For example, improvement of the write performance may be restricted to obtain a desired level of data reliability. On the other hand, data reliability may be restricted to obtain a desired level of write performance. Data reliability and write performance may depend on the above-described conditions. That is, the data reliability may vary according to an increase in write performance. After the SMT step is carried out, a write mode may be decided to improve the write performance while securing the data reliability. For example, in step S440, there is selected a write mode having a maximum write performance better than a write performance of a normal write mode and the pre-SMT write performance.

After a write mode of memory 1300 is set up, in step S460, various application programs of a mobile device on which memory 1300 is mounted may be downloaded from computing device 2000 into memory 1300. Here, downloading may include an operation of transferring data from computing device 2000 to memory 1300 and an operation of programming the transferred data in memory 1300 (or, storage medium of memory 1300). Data transferred from computing device 2000 may be stored in a storage medium of memory 1300 according to conditions of the write mode set in step S440. For example, data transferred from computing device 2000 may be stored in a storage medium of memory 1300 according to the SLC program manner (in case of an MLC memory) or according to an SLC/MCL program manner (in case of a TLC memory). In this case, a background operation such as garbage collection may be held. Also, in some cases, program time tPROG may be shortened.

In step S480, computing device 2000 sets memory 1300 with information indicating an end of the post-SMT write operation. Afterwards, the post-SMT write operation may be ended.

In some embodiments, a background operation delayed in step S460 may be performed within memory 1300 at a designated time point. This will described in further detail with reference to accompanying drawings.

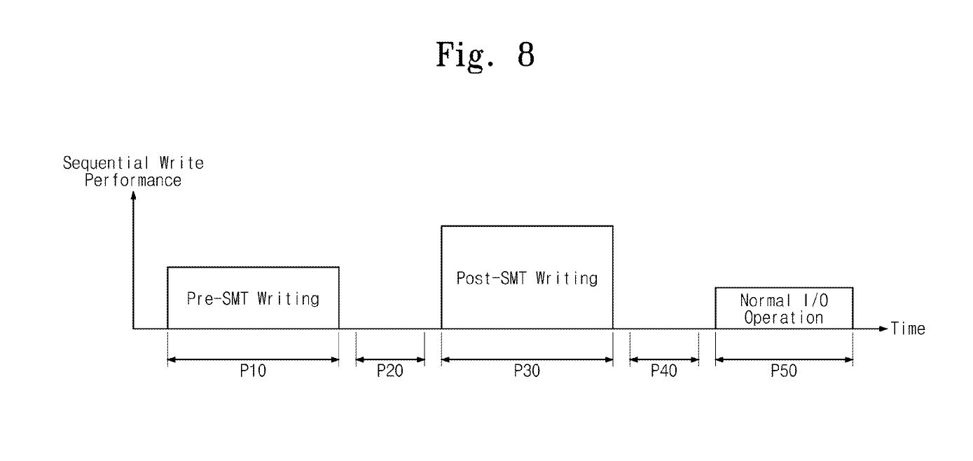

FIG. 8 is a diagram illustrating a mass production procedure comprising a pre-SMT write step and a post-SMT write step, according to an embodiment of the inventive concept. In FIG. 8, a horizontal axis indicates a mass production time, and a vertical axis indicates a sequential write performance.

A mass production procedure shown in FIG. 8 comprises a pre-SMT write step P10, an SMT step P20, a post-SMT write step P30, a post processing step P40 and a normal input/output operation P50. However, the inventive concept is not limited thereto. In the SMT step P20, a nonvolatile memory device may be mounted on a mobile device. In pre-SMT write step P10, a nonvolatile memory device (See, e.g., FIG. 2) may be connected to a computing device. Likewise, in post-SMT write step P30, a mobile device 1000 including a memory (See, e.g., FIG. 5) may be connected to a computing device. As understood from FIG. 8, a time taken to perform pre-SMT write step P10 and a time taken to perform post-SMT write step P30 may occupy most of a mass production time. This means that the mass production time is shortened by shortening such write times.

In some embodiments, an operation corresponding to pre-SMT write step P10 may be performed substantially the same as described with reference to FIG. 3 or 4. An operation corresponding to post-SMT write step P30 may be performed substantially the same as described with reference to FIG. 6 or 7.

A sequential write performance of pre-SMT write step P10 is lower than that of post-SMT write step P30. On the other hand, reliability of pre-SMT write step P10 is higher than that of post-SMT write step P30. A write mode of a nonvolatile memory device/memory device may be set to satisfy such a condition. Also, as illustrated in FIG. 8, a sequential write performance of pre-SMT write step P10 and a sequential write performance of post-SMT write step P30 may be higher than a sequential write performance of a normal input/output operation P50. For example, assuming that a write mode of the normal input/output operation P50 is a default write mode, a write performance of the default write mode may be lower than sequential write performances of pre-SMT write step P10 and post-SMT write step P30. This means that a time taken to perform pre-SMT write step P10 and a time taken to perform post-SMT write step P30 are shortened. Thus, it is possible to shorten the mass production time.

Background operations (e.g., garbage collection, etc.) held in pre-SMT write step P10 and post-SMT write step P30 may be performed in the post processing step P40. Unlike pre-SMT write step P10 and post-SMT write step P30, a mobile device may be detached from a computing device during the post processing step P40. Because the held background operations are performed with the mobile device detached from the computing device, a time taken to perform the background operations may not affect the mass production time. The post processing step P40, also, may include operations of detecting an area where a characteristic of a nonvolatile memory device/memory device is deteriorated and performing a data refresh operation where data of the detected area is refreshed. All or any one of the garbage collection operation and the data refresh operation may be performed in the post processing step P40.

For ease of description, FIG. 8 shows an embodiment in which steps P10 to P40 are continuing on the same time axis. However, because the step P40 can be performed at any time of a mass production procedure when a nonvolatile memory device (See, e.g., FIG. 2) or a memory (See, e.g., FIG. 5) is detached from a computing device, it may be performed during a download operation.

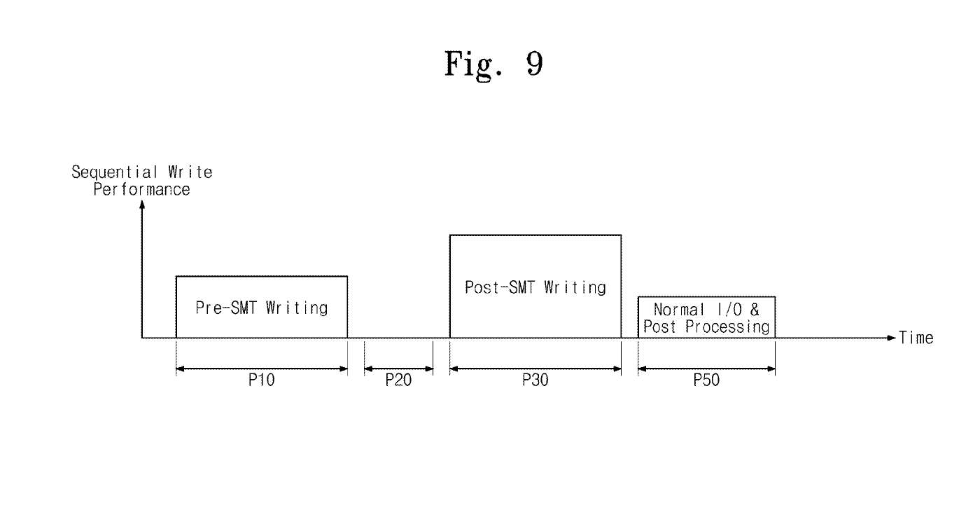

FIG. 9 is a diagram illustrating a mass production procedure comprising a pre-SMT write step and a post-SMT write step, according to another embodiment of the inventive concept. In FIG. 9, a horizontal axis indicates a mass production time, and a vertical axis indicates a sequential write performance.

A mass production procedure shown in FIG. 9 comprises pre-SMT write step P10, an SMT step P20, post-SMT write step P30, and the normal input/output and post processing step P50. In the SMT step P20, a nonvolatile memory device may be mounted on a mobile device. In pre-SMT write step P10, a nonvolatile memory device (See, e.g., FIG. 2) may be connected to a computing device. Likewise, in post-SMT write step P30, mobile device 1000 comprising a memory (See, e.g., FIG. 5) may be connected to a computing device. As understood from FIG. 9, a time taken to perform pre-SMT write step P10 and a time taken to perform post-SMT write step P30 may occupy most of a mass production time. This means that the mass production time is shortened by shortening such write times.

In some embodiments, an operation corresponding to pre-SMT write step P10 may be performed substantially the same as described with reference to FIG. 3 or 4. An operation corresponding to post-SMT write step P30 may be performed substantially the same as described with reference to FIG. 6 or 7.

A sequential write performance of pre-SMT write step P10 is lower than that of post-SMT write step P30. On the other hand, reliability of pre-SMT write step P10 is higher than that of post-SMT write step P30. A write mode of a nonvolatile memory device/memory device may be set to satisfy such a condition. Also, as illustrated in FIG. 9, a sequential write performance of pre-SMT write step P10 and a sequential write performance of post-SMT write step P30 may be higher than a sequential write performance of a normal input/output operation of the normal input/output and post processing step P50. For example, assuming that a write mode of the normal input/output operation is a default write mode, a write performance of the default write mode may be lower than sequential write performances of pre-SMT write step P10 and post-SMT write step P30. This means that a time taken to perform pre-SMT write step P10 and a time taken to perform post-SMT write step P30 are shortened. Thus, it is possible to shorten the mass production time.

Background operations (e.g., garbage collection, etc.) held in pre-SMT write step P10 and post-SMT write step P30 may be performed in the normal input/output and post processing step P50. Unlike pre-SMT write step P10 and post-SMT write step P30, a mobile device may be detached from a computing device during the normal input/output and post processing step P50. Because the held background operations are performed with the mobile device detached from the computing device, a time taken to perform the background operations may not affect the mass production time. The normal input/output and post processing step P50, also, may include operations of detecting an area where a characteristic of a nonvolatile memory device/memory device is deteriorated and performing a data refresh operation where data of the detected area is refreshed.

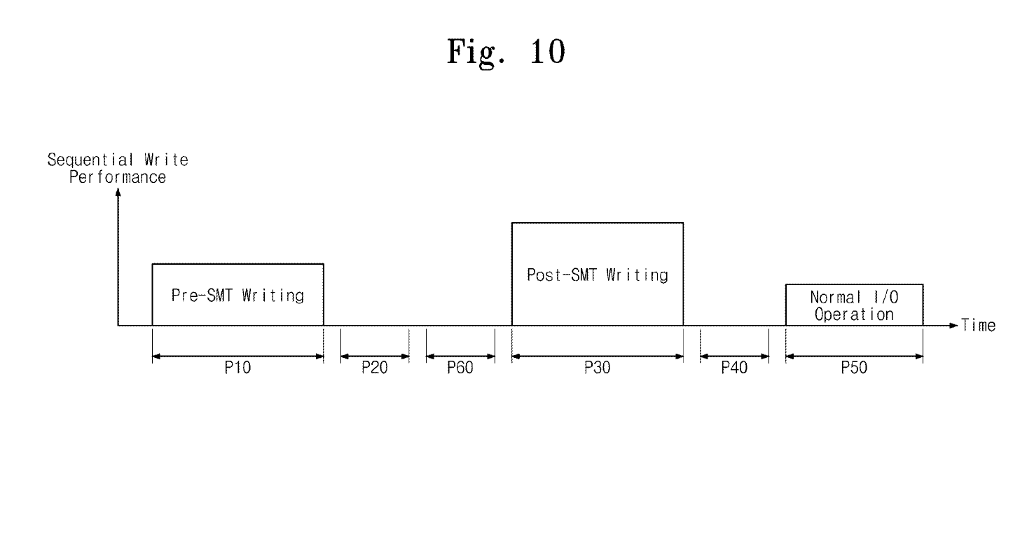

FIG. 10 is a diagram illustrating a mass production procedure comprising a pre-SMT write step and a post-SMT write step, according to still another embodiment of the inventive concept. In FIG. 10, a horizontal axis indicates a mass production time, and a vertical axis indicates a sequential write performance.

A mass production procedure in the method of FIG. 10 comprises pre-SMT write step P10, SMT step P20, a first post processing step P60, post-SMT write step P30, a second post processing step P40, and a normal input/output operation P50. However, the inventive concept is not limited thereto. In the SMT step P20, a nonvolatile memory device may be mounted on a mobile device. In pre-SMT write step P10, a nonvolatile memory device (See, e.g., FIG. 2) may be connected to a computing device. Likewise, in post-SMT write step P30, a mobile device 1000 including a memory (See, e.g., FIG. 5) may be connected to a computing device. As understood from FIG. 10, a time taken to perform pre-SMT write step P10 and a time taken to perform post-SMT write step P30 may occupy most of a mass production time. This means that the mass production time is shortened by shortening such write times.

In some embodiments, an operation corresponding to pre-SMT write step P10 may be performed substantially the same as described with reference to FIG. 3 or 4. An operation corresponding to post-SMT write step P30 may be performed substantially the same as described with reference to FIG. 6 or 7.

A sequential write performance of pre-SMT write step P10 is lower than that of post-SMT write step P30. On the other hand, reliability of pre-SMT write step P10 is higher than that of post-SMT write step P30. A write mode of a nonvolatile memory device/memory device may be set to satisfy such a condition. Also, as illustrated in FIG. 10, a sequential write performance of pre-SMT write step P10 and a sequential write performance of post-SMT write step P30 may be higher than a sequential write performance of a normal input/output operation P50. For example, assuming that a write mode of the normal input/output operation P50 is a default write mode, a write performance of the default write mode may be lower than sequential write performances of pre-SMT write step P10 and post-SMT write step P30. This means that a time taken to perform pre-SMT write step P10 and a time taken to perform post-SMT write step P30 are shortened. Thus, it is possible to shorten the mass production time.

Background operations (e.g., garbage collection, etc.) held in pre-SMT write step P10 may be performed in the first post processing step P60. Unlike pre-SMT write step P10 and post-SMT write step P30, a mobile device may be detached from a computing device during the first and second post processing steps P60 and P40. Because the held background operations are performed with the mobile device detached from the computing device, a time taken to perform the background operations may not affect the mass production time. Each of first and second post processing steps P60 and P40 may further comprise operations of detecting an area where a characteristic of a nonvolatile memory device/memory device is deteriorated and performing a data refresh operation where data of the detected area is refreshed. All or any one of the garbage collection operation and the data refresh operation may be performed in the second post processing step P40.

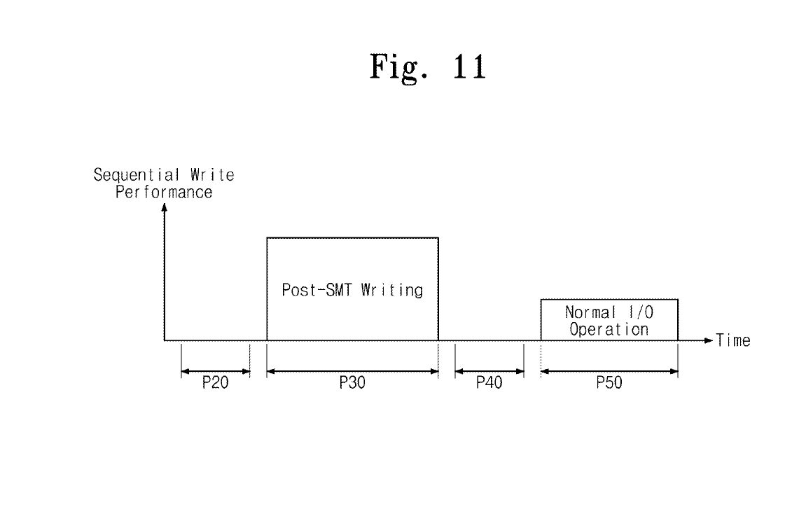

FIG. 11 is a diagram illustrating a mass production procedure comprising a post-SMT write step, according to a further embodiment of the inventive concept. In FIG. 11, a horizontal axis indicates a mass production time, and a vertical axis indicates a sequential write performance.

A mass production procedure in the method of FIG. 11 comprises SMT step P20, post-SMT write step P30, post processing step P40, and normal input/output step P50. However, the inventive concept is not limited thereto. In SMT step P20, nonvolatile memory device may be mounted on a mobile device. In post-SMT write step P30, mobile device 1000 comprising a memory (See, e.g., FIG. 5) is connected to a computing device. In post-SMT write step P30, data (e.g., a boot loader, an OS image, and the like) for basic operations of a mobile device and application programs of the mobile device is downloaded into a memory device of the mobile device. As understood from FIG. 11, a time taken to perform post-SMT write step P30 may occupy most of a mass production time. This means that the mass production time is shortened by shortening the time taken to perform post-SMT write step P30.

In some embodiments, an operation corresponding to post-SMT write step P30 may be performed substantially the same as described with reference to FIG. 6 or 7.

As illustrated in FIG. 11, a sequential write performance of post-SMT write step P30 may be higher than a sequential write performance of normal input/output operation P50. For example, assuming that a write mode of the normal input/output operation P50 is a default write mode, a write performance of the default write mode may be lower than a sequential write performance of post-SMT write step P30. This means that a time taken to perform post-SMT write step P30 is shortened. Thus, it is possible to shorten the mass production time.

Background operations (e.g., garbage collection, etc.) held in post-SMT write step P30 may be performed in the post processing step P40. Unlike post-SMT write step P30, a mobile device may be detached from a computing device during the post processing step P40. Because the held background operations are performed with the mobile device detached from the computing device, a time taken to perform the background operations may not affect the mass production time. The post processing step P40, also, may include operations of detecting an area where a characteristic of a nonvolatile memory device/memory device is deteriorated and performing a data refresh operation where data of the detected area is refreshed. All or any one of the garbage collection operation and the data refresh operation may be performed in the post processing step P40.

In FIG. 5, in the event that a communication interface 1200 of a mobile device 1000 is connected to a computing device 2000 according to the USB protocol, supportable write modes of a memory device 1300 in mobile device 1000 may be restricted according to an interface speed between mobile device 10000 and computing device 2000. This will be more fully described later.

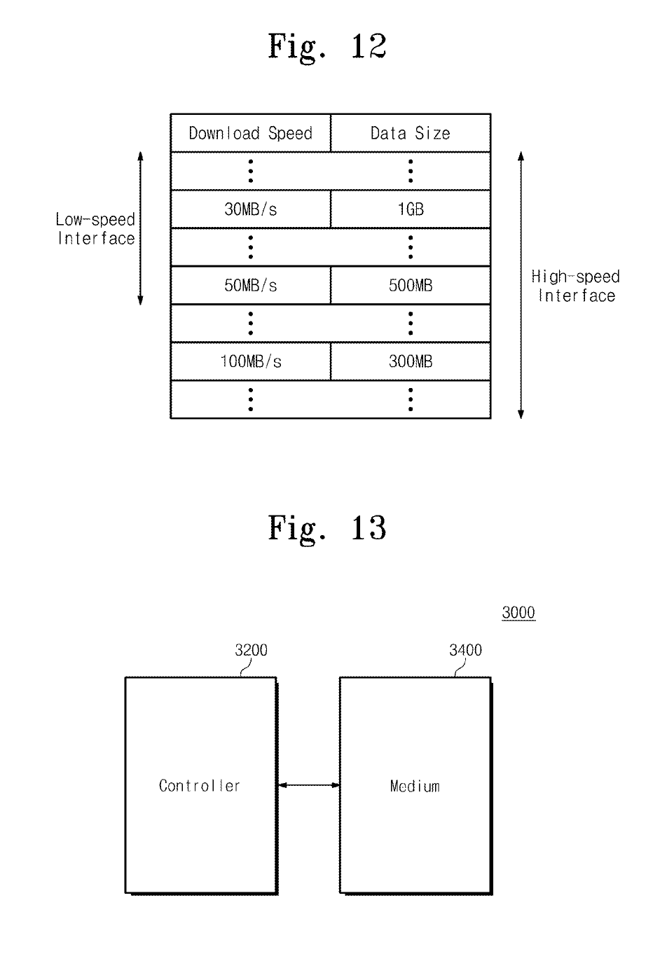

FIG. 12 is a diagram illustrating a method of selecting supportable write modes of a memory device in a mobile device according to an interface speed between a mobile device and a computing device.

Supportable write modes of a memory 1300 in a mobile device 1000 may have different download speeds. For example, referring to FIG. 12, a write mode (or, a download speed) may be selected according to the size of data to be downloaded. As described above, downloading may include an operation of transferring data from an external device (e.g., a computing device) to main storage (or, a nonvolatile memory device/memory device) of a mobile device and an operation of programming the transferred data in a storage medium of the nonvolatile memory device/memory device.

In the event that an interface between a mobile device 1000 and a computing device 2000 is a high-speed interface (e.g., USB 3.0), computing device 2000 may perform a register setting operation about a memory device 1300 such that there is selected a download speed corresponding to one of supportable write modes of the memory device 1300 in mobile device 1000.

In the event that the interface between mobile device 1000 and computing device 2000 is a low-speed interface (e.g., USB 2.0), computing device 2000 may perform a register setting operation about the memory device 1300 such that there is selected a download speed corresponding to one of some of supportable write modes of the memory device 1300 in mobile device 1000.

In some embodiments, if mobile device 1000 is connected to download files, supportable write modes or download speeds may be displayed through a display device 1500 of mobile device 1000. A user may select one of the download speeds according to the size of data to be downloaded, and a file may be downloaded into memory device 1300 in mobile device 1000 according to the selected download speed. A background operation may be held during the write mode corresponding to the selected download speed. After the download operation is completed, the held background operation may be performed during an idle time.

Write modes supported by a nonvolatile memory device 200 or a memory 1300 may include, e.g., (1) a write mode which has a high level of reliability, a write performance between a default write performance and a maximum write performance, a long post processing time, a small size of data to be downloaded, (2) a write mode which has an intermediate level of reliability, the maximum write performance, a long post processing time, an intermediate size of data to be downloaded, and (3) a write mode which has an intermediate level of reliability, a write performance between a default write performance and a maximum write performance, an intermediate post processing time, a large size of data to be downloaded.

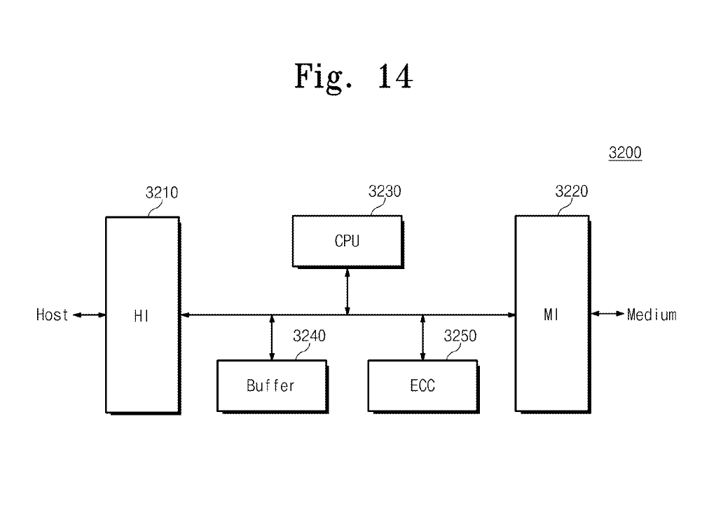

FIG. 13 is a block diagram illustrating a nonvolatile memory device according to an embodiment of the inventive concept.

Referring to FIG. 13, a nonvolatile memory device 3000 comprises a memory controller 3200 and storage medium 3400 implemented by a multi-bit/multi-level memory device. Memory controller 3200 is configured to control storage medium 3400 according to an external request (e.g., a write request, a read request, and the like). Memory controller 3200 is configured to control storage medium 3400 according to an internal request (e.g., a held background operation, an operation associated with sudden power-off, a wear-leveling operation, a read reclaim operation, etc.) without an external request. Storage medium 3400 operates in response to a control of memory controller 3200 and comprises one or more memory chips. Storage medium 3400 and memory controller 3200 communicate via one or more channels. Storage medium 3400 may be a NAND flash memory device, for example.

Memory controller 3200 is configured to change write modes according to information (e.g., information indicating a write operation to be performed before an SMT step) from an external device. For example, where received information indicates that a write operation of nonvolatile memory device 3000 is a write operation to be performed before the SMT step, a write mode is selected with a write performance between a write performance of a normal write mode and a post-SMT write performance. Alternatively, where received information indicates that a write operation of nonvolatile memory device 3000 is a write operation to be performed after the SMT step, a write mode is selected having a maximum write performance. Memory controller 3200 controls a write operation of storage medium 3400 according to the selected write mode. A background operation held during the write operation may be treated as described with reference to one of FIGS. 8 to 11.

In some embodiments, memory controller 3200 and storage medium 3400 may constitute a multi-media card (MMC) or an embedded MMC (eMMC) directly mounted on a board of a portable electronic device. However, the inventive concept is not limited thereto.

In some embodiments, nonvolatile memory device 3000 may comprise a storage medium 3400 used to store data; and a controller 3200 configured to control the storage medium. Controller 3200 may be configured to variably control a download speed where data provided from an external device is stored in storage medium 3400, based on setting information provided from the external device. The download speed may be varied by a program manner and a program time of storage medium 3400 and by a background operation of the controller. Storage medium 3400 is formed of a MLC memory device having a MLC program manner and a SLC program manner. The download speed is varied by one of operations of setting a program manner of the MLC memory device to the SLC program manner, changing a program time for storing data in the MLC memory device, and delaying an execution time point of the background operation or by a combination of two or more thereof. The setting information may include information indicating whether an assembly process of nonvolatile memory device 3000 is completed at a mass production level. Where the setting information indicates that nonvolatile memory device 3000 exists at a mass production level, a download speed may be selected to have a write performance better than a write performance of a normal write mode of the storage medium. A write performance corresponding to a download speed selected when the setting information indicates that an assembly process of nonvolatile memory device 3000 is completed at a mass production level is better than a write performance corresponding to a download speed selected when the setting information indicates that an assembly process of nonvolatile memory device 3000 is not completed at a mass production level. Multiple download speeds may be supported by nonvolatile memory device 3000, and controller 3200 may support all or a part of the download speeds according to an interface speed with the external device. Where nonvolatile memory device 3000 is connected to an external device for data downloading, controller 3200 may display the download speeds so as to be selected by a user.

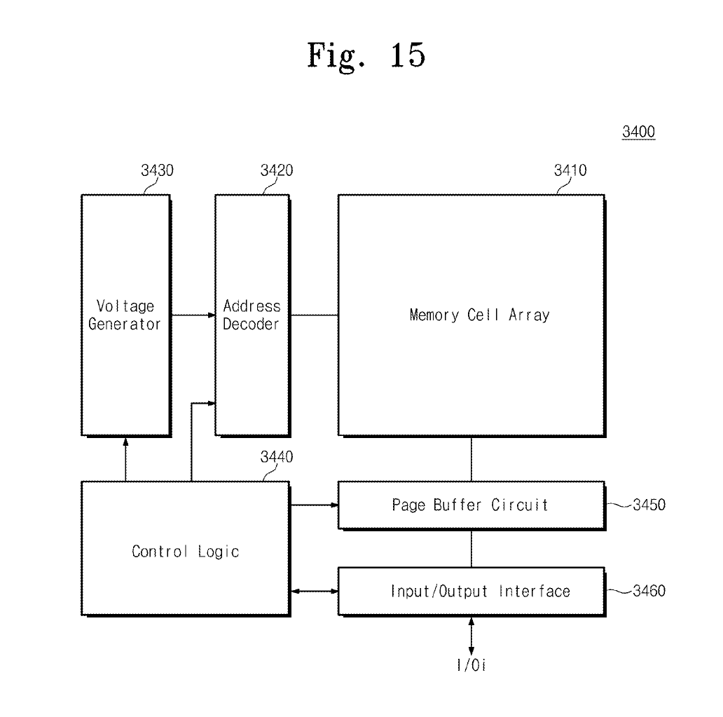

FIG. 14 is a block diagram illustrating a memory controller in the method of FIG. 13.

Referring to FIG. 14, memory controller 3200 comprises a host interface 3210 as a first interface, a memory interface 3220 as a second interface, a central processing unit (CPU) 3230, a buffer memory 3240, and an error detecting and correcting circuit 3250.

Host interface 3210 is configured to interface with an external device (e.g., a host), and memory interface 3220 is configured to interface with a storage medium 3400 illustrated in FIG. 13. CPU 3230 controls overall operation of controller 3200. CPU 3230 may be configured to operate firmware such as Flash Translation Layer (FTL), for example. The FTL may perform a variety of functions. For example, the FTL may include a variety of layers performing an address mapping operation, a read reclaim operation, an error correction operation, and so on. When there is received information indicating that a current write operation is a write operation to be performed before an SMT step, CPU 3230 (or, FTL executed by CPU 3230) may select a write mode having a write performance between a write performance of a normal write mode and a post-SMT write performance. Also, when there is received information indicating that a current write operation is a write operation to be performed after an SMT step, CPU 3230 (or, FTL executed by CPU 3230) may select a write mode having a maximum write performance.

Buffer memory 3240 is used to temporarily store data to be transferred from an external device via host interface 3210 or data to be transferred from storage medium 3400 via memory interface 3220. Buffer memory 3240 is used to store information (e.g., address mapping information and the like) needed to control storage medium 3400. Buffer memory 3240 may be formed of, e.g., DRAM, SRAM, or a combination of DRAM and SRAM. ECC 3250 is configured to encode data to be stored in storage medium 3400 and to decode data read out from storage medium 3400.

Although not illustrated in figures, memory controller 3200 may further comprise a randomizer/de-randomizer configured to randomize data to be stored in storage medium 3400 and to de-randomize data read from storage medium 3400. Examples of the randomizer/de-randomizer are disclosed in U.S. Patent Publication No. 2010/0088574, the subject matter of which is hereby incorporated by reference.

Host interface 3210 may be implemented by one of various computer bus standards, storage bus standards, and iFCPPeripheral bus standards, or a combination of two or more standards. The computer bus standards may include S-100 bus, Mbus, Smbus, Q-Bus, ISA, Zorro II, Zorro III, CAMAC, FASTBUS, LPC, EISA, VME, VXI, NuBus, TURBOchannel, MCA, Sbus, VLB, PCI, PXI, HP GSC bus, CoreConnect, InfiniBand, UPA, PCI-X, AGP, PCIe, Intel QuickPath Interconnect, Hyper Transport, and the like. The storage bus standards may include ST-506, ESDI, SMD, Parallel ATA, DMA, SSA, HIPPI, USB MSC, FireWire (1394), Serial ATA, eSATA, SCSI, Parallel SCSI, Serial Attached SCSI, Fibre Channel, iSCSI, SAS, RapidIO, FCIP, etc. The iFCPPeripheral bus standards may include Apple Desktop Bus, HIL, MIDI, Multibus, RS-232, DMX512-A, EIA/RS-422, IEEE-1284, UNI/O, 1-Wire, I2C, SPI, EIA/RS-485, USB, Camera Link, External PCIe, Light Peak, Multidrop Bus, and the like.

FIG. 15 is a block diagram illustrating a storage medium in the method of FIG. 13.

Storage medium 3400 may be a nonvolatile memory device such as a NAND flash memory device, for example. However, it is understood that storage medium 3400 is not limited to the NAND flash memory device. For example, concepts described with respect to the NAND flash memory device could alternatively be applied to a NOR flash memory device, Resistive Random Access Memory (RRAM) device, a Phase-Change Memory (PRAM) device, a Magnetroresistive Random Access Memory (MRAM) device, a Ferroelectric Random Access Memory (FRAM) device, a Spin Transfer Torque Random Access Memory (STT-RAM), and the like. Further, nonvolatile memory device 1400 can be implemented to have a three-dimensional array structure. A nonvolatile memory device with the three-dimensional array structure may be referred to as a vertical NAND flash memory device. The above described concepts may also be applied to a Charge Trap Flash (CTF) memory device comprising a charge storage layer formed of an insulation film as well as a flash memory device including a charge storage layer formed of a conductive floating gate.

Referring to FIG. 15, storage medium 3400 comprises a memory cell array 3410, an address decoder 3420, a voltage generator 3430, control logic 3440, a page buffer circuit 3450, and an input/output interface 3460.

Memory cell array 3410 comprises memory cells arranged at intersections of rows (e.g., word lines) and columns (e.g., bit lines). Each memory cell may store 1-bit data or M-bit data as multi-bit data (M>1). Address decoder 3420 is controlled by control logic 3440, and it performs selecting and driving operations on rows (e.g., word lines, a string selection line(s), a ground selection line(s), a common source line, etc.) of memory cell array 3410. Voltage generator 3430 is controlled by control logic 3440 and generates voltages required for each operation such as a high voltage, a program voltage, a read voltage, a verification voltage, an erase voltage, a pass voltage, a bulk voltage, and the like. Voltages generated by voltage generator 3430 are provided to memory cell array 3410 via address decoder 3420. Control logic 3440 is configured to control an overall operation of storage medium 3400.

Page buffer circuit 3450 is controlled by control logic 3440 and is configured to read data from memory cell array 3410 and to drive columns (e.g., bit lines) of memory cell array 3410 according to program data. Page buffer circuit 3450 may include page buffers respectively corresponding to bit lines or bit line pairs. Each of the page buffers may include multiple latches. Input/output interface 4460 is controlled by control logic 3440 and interfaces with an external device (e.g., a memory controller 3200 in the method of FIG. 13). Although not illustrated in FIG. 15, input/output interface 3460 may include a column decoder configured to select page buffers of page buffer circuit 3450 by a predetermined unit, an input buffer receiving data, an output buffer outputting data, and so on.

In some embodiments, control logic 3440 is configured to change a program time tPROG according to a control of memory controller 3200. For example, control logic 3440 may control voltage generator 3420 such that a start level of the program voltage is changed. Alternatively, control logic 3440 may restrict the number of program loops according to a control of memory controller 3200. Program time tPROG may be changed by varying the start level of the program voltage, the number of program loops, and like.

In some embodiments, memory cells can be formed of a variable resistance memory cell. Examples of variable resistance memory cells and memory devices comprising the same are disclosed in U.S. Pat. No. 7,529,124, the subject matter of which is hereby incorporated by reference.

In certain other embodiments, memory cells can be formed of one of various cell structures having a charge storage layer. Cell structures having a charge storage layer include a charge trap flash structure using a charge trap layer, a stack flash structure in which arrays are stacked at multiple layers, a source-drain free flash structure, a pin-type flash structure, and the like.

Examples of memory devices having a charge trap flash structure as a charge storage layer are disclosed in U.S. Pat. No. 6,858,906 and U.S. Patent Publication Nos. 2004/0169238 and 2006/0180851, the subject matter of which is hereby incorporated by reference. A source-drain free flash structure is disclosed in KR Patent No. 673020, the subject matter of which is hereby incorporated by reference.

Nonvolatile memory devices and/or memory controllers as described above may be packaged according to any of a various different packaging technologies. Examples of such packaging technologies include Package on Package (PoP), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

While the inventive concept has been described with reference to certain embodiments, it will be apparent to those skilled in the art that various changes and modifications may be made to the described embodiments without departing from the scope of the inventive concept. Therefore, it should be understood that the above embodiments are not limiting, but illustrative.

1. A system comprising:
a nonvolatile memory device having multiple download speeds; and
a computing device configured to be connected to the nonvolatile memory device, to determine a download environment of the nonvolatile memory device, and to set the nonvolatile memory device to one of the download speeds according to the determined download environment.

2. The system of claim 1, wherein the download speeds correspond to different mass production write modes of the nonvolatile memory device, and the different mass production write modes have different write performances.

3. The system of claim 2, wherein each of the download speeds is determined by a program manner and a program time of the nonvolatile memory device.

4. The system of claim 3, wherein the nonvolatile memory device comprises a storage medium comprising a multi-level cell (MLC) memory having an MLC program manner and a single-level cell (SLC) program manner, the MLC memory being configured to store data, and
wherein a download speed of the nonvolatile memory device is changed by setting the program manner of the nonvolatile memory device to the SLC program manner or by changing the program time for storing data in the storage medium.

5. The system of claim 4, wherein a background operation of a mass production write mode, among the mass production write modes, corresponding to the set download speed is held until the nonvolatile memory device is detached from the computing device.

6. (canceled)

7. The system of claim 2, wherein, in conjunction with non-performance of an assembly process of mounting the nonvolatile memory device on a mobile device, a download speed of the nonvolatile memory device is selected to have a write performance lower than a maximum write performance among write performances of the mass production write modes that are better than a write performance of a normal write mode of the nonvolatile memory device.

8. The system of claim 2, wherein, in conjunction with performance of an assembly process of mounting the nonvolatile memory device on a mobile device, a download speed of the nonvolatile memory device is selected to have a maximum write performance among write performances of the mass production write modes.

9-10. (canceled)

11. A nonvolatile memory device, comprising:
a storage medium configured to store data; and
a controller configured to control the storage medium,
wherein the controller is configured to variably control a download speed where data provided from an external device is stored in the storage medium, based on setting information provided from the external device.

12. The nonvolatile memory device of claim 11, wherein the download speed is varied by a program manner and a program time of the storage medium and by a background operation of the controller.

13. The nonvolatile memory device of claim 12, wherein the storage medium comprises a multi-level cell (MLC) memory having a MLC program manner and a single-level cell (SLC) program manner, and
wherein the download speed of the nonvolatile memory device is varied by at least one operation among (a) setting a program manner of the MLC memory to the SLC program manner, (b) changing a program time for storing data in the MLC memory, and (c) delaying execution of the background operation.

14. The nonvolatile memory device of claim 13, wherein the background operation comprises at least one of a garbage collection operation and a data refresh operation.

15. The nonvolatile memory device of claim 11, wherein the setting information comprises information indicating whether an assembly process of the nonvolatile memory device is completed at a mass production level.

16. The nonvolatile memory device of claim 15, wherein where the setting information indicates that the nonvolatile memory device is at the mass production level, the download speed is selected to have a write performance better than a write performance of a normal write mode of the storage medium.

17. The nonvolatile memory device of claim 16, wherein a write performance corresponding to the download speed selected when the setting information indicates that the assembly process of the nonvolatile memory device is completed at the mass production level is better than a write performance corresponding to the download speed selected when the setting information indicates that the assembly process of the nonvolatile memory device is not completed at the mass production level.

18. The nonvolatile memory device of claim 11, wherein multiple download speeds are supported by the nonvolatile memory device, and the controller is configured to support some or all of the download speeds according to an interface speed with the external device.

19. The nonvolatile memory device of claim 18, wherein where the nonvolatile memory device is connected to the external device for data downloading, the controller is configured to display the download speeds so as to be selected by a user.

20. A method, comprising:
performing a pre surface mount technology (SMT) write operation where data is downloaded from a computing device into a nonvolatile memory device having multiple mass production download speeds, the nonvolatile memory device being set to one of the mass production download speeds by the computing device;
mounting the nonvolatile memory device on a mobile device; and
performing a post-SMT write operation where data is downloaded from the computing device into the nonvolatile memory device mounted on the mobile device, the nonvolatile memory device being set to a mass production download speed used for the pre-SMT write operation or to one of remaining mass production download speeds other than the mass production download speed used for the pre-SMT write operation,
wherein a write performance corresponding to the mass production download speed used for the pre-SMT write operation and a write performance corresponding to a mass production download speed used for the post-SMT write operation are better than a write performance corresponding to a normal download speed of the nonvolatile memory device.

21. The method of claim 20, wherein the mass production download speeds are varied by a program manner and a program time of the nonvolatile memory device and by a background operation associated with a write operation of the downloaded data.

22. The method of claim 21, wherein the nonvolatile memory device comprises a storage medium which is formed of a multi level cell (MLC) memory having a MLC program manner and a single level cell (SLC) program manner, the MLC memory being configured to store data, and
wherein the mass production download speeds are implemented by at least one of operations from among setting a program manner of the nonvolatile memory device to the SLC program manner, changing a program time for storing data in the storage medium, and delaying execution of the background operation.

23. The method of claim 22, wherein the background operation associated with the write operation of the downloaded data is held until the nonvolatile memory device is detached from the computing device, and
wherein the held background operation is performed at a state where the nonvolatile memory device is disconnected from the computing device.

24-25. (canceled)
